(19) United States
(12) Patent Application Publication
(10) Pub. No.: US 2015/0167597 A1
(43) Pub. Date: Jun. 18, 2015

(54) EVAPORATED FUEL PROCESSING DEVICE

(71) Applicant: TOYOTA JIDOSHA KABUSHIKI KAISHA, Toyota-shi, Aichi-ken (JP)

(72) Inventors: Yuichi Nagasaku, Okazaki-shi (JP); Shuichi Aso, Toyota-shi (JP); Katsunori Kamiya, Kariya-shi (JP); Kazuhiro Yoneshige, Nagoya-shi (JP)

(73) Assignee: TOYOTA JIDOSHA KABUSHIKI KAISHA, Toyota-shi, Aichi-ken (JP)

(21) Appl. No.: 14/417,907

(22) PCT Filed: Jul. 30, 2013
(86) PCT No.: PCT/JP13/04594

§ 371 Date: Jan. 28, 2015

(30) Foreign Application Priority Data
Jul. 31, 2012 (JP) 2012-169426
Nov. 22, 2012 (JP) 2012-256410

(51) Int. Cl. F02M 25/08

(52) U.S. Cl. CPC F02M 25/089; F02M 25/0854

(57) ABSTRACT

If it is determined that an internal temperature Tc of a canister that is formed with a heat transfer surface for guiding fuel that flows through a fuel tank during actuation of a fuel pump is lower than a specified temperature To (step S1), the ECU determines whether a driving voltage of the fuel pump is a high driving voltage (step S2). If it is determined that the driving voltage of the fuel pump is not the high driving voltage, an FPC is controlled, and the driving voltage of the fuel pump is increased (step S3, S5). Accordingly, a current that flows through the fuel pump is increased, so as to heat discharged fuel.

### TECHNICAL FIELD

The present invention relates to an evaporated fuel processing device.

### BACKGROUND ART

Conventionally, an internal combustion engine (hereinafter also referred to as an “engine”) for driving a vehicle that is operated by high-volatile fuel is equipped with an evaporated fuel processing device in which evaporated fuel, which is generated in a fuel tank or the like, is absorbed by an absorber that uses an absorbent (hereinafter also referred to as a “canister”) and performs a purge operation. In the purge operation, the fuel is desorbed from the canister during the operation of the engine and is guided into an intake passage of the engine.

Activated carbon is primarily used as the absorbent that is used in the canister. A capacity of the activated carbon to absorb the fuel is enhanced at a lower temperature, and a capacity of the activated carbon to desorb the absorbed fuel is enhanced at a higher temperature. In other words, it is desirable that an internal temperature of the canister is high when the fuel is desorbed and that the internal temperature of the canister is low when the fuel is absorbed.

An evaporated fuel processing device, which has conventionally been known, has a casing that includes an outer wall surface and an inner wall surface and in which an inner side of the inner wall surface is hollow. A portion between the outer wall surface and the inner wall surface constitutes an absorbent housing section that houses an absorbent for absorbing vaporized fuel. The absorbent housing section serves as a canister. A hollow space, which is formed on the inner side of the inner wall surface, constitutes a pump mounting section in which a fuel pump for pumping the fuel is arranged. The canister and the fuel pump are integrated as a unit (for example, see Patent Document 1).

In this conventional evaporated fuel processing device, the casing, which houses this unit, is arranged in a fuel tank that houses the fuel pumped by the fuel pump, and an attachment section is provided to attach the casing to the fuel tank such that a lower portion of the casing is arranged near the bottom of the fuel tank.

Furthermore, in the conventional evaporated fuel processing device, a communication section for communicating between the pump mounting section and the fuel tank is formed in the lower portion of the casing, and an intake port of the fuel pump is arranged in the lower portion of the casing.

With such a configuration, in the conventional evaporated fuel processing device, heat that is generated by actuation of the fuel pump is transferred to the absorber and causes the fuel, which has been absorbed by the absorbent in the absorber, to be easily purged. During a stop of the engine, the absorber is cooled in conjunction with a reduction in the temperature of gasoline, and the evaporated fuel is easily absorbed by the absorbent in the absorber.

### PRIOR ART DOCUMENT

### Patent Document

Patent Document 1: Japanese Patent Application Publication No. 2006-257935 (JP 2006-257935 A)

### SUMMARY OF THE INVENTION

### Problem to be Solved by the Invention

However, in such a conventional evaporated fuel processing device described in Patent Document 1, a temperature of the fuel that is discharged from the fuel pump becomes relatively low when discharged fuel pressure of the fuel pump is low. As a result, there remains a problem that a temperature of the absorber cannot be increased sufficiently and thus evaporated fuel desorbing performance of the absorber cannot be exerted sufficiently.

In view of the above, the present invention has an object to provide an evaporated fuel processing device that can sufficiently exert desorbing performance of an absorber in comparison with the conventional evaporated fuel processing device.

### Means for Solving the Problem

In order to achieve the above object, an evaporated fuel processing device of the present invention includes: a fuel tank that stores fuel for an internal combustion engine; a fuel pump that pumps up the fuel that is supplied from the fuel tank to the internal combustion engine; an absorber that is mounted in the fuel tank and absorbs evaporated fuel generated in the fuel tank; and a purge mechanism in which the evaporated fuel is introduced from the absorber into an intake pipe of the internal combustion engine. The evaporated fuel processing device is configured by including: a temperature increase request section that requests an increase of a temperature of the absorber; and a transferred heat amount control section that increases an amount of heat transferred from the fuel pump to the absorber under a condition that the increase of the temperature of the absorber is requested by the temperature increase request section.

With this configuration, the amount of the heat that is transferred from the fuel pump to the absorber is increased when the increase of the temperature of the absorber is requested, and thus desorbing performance of the absorber during a purge operation is improved. Therefore, in comparison with a conventional evaporated fuel processing device, the evaporated fuel processing device of the present invention can sufficiently exert the desorbing performance of the absorber.

Noted that the transferred heat amount control section may increase the amount of heat that is transferred from the fuel pump to the absorber via the fuel.

With this configuration, the evaporated fuel processing device of the present invention can heat the absorber by the fuel that is heated by the fuel pump.

Noted that the transferred heat amount control section may increase the amount of heat that is transferred from the fuel pump to the absorber via the fuel that is discharged from the fuel pump.

With this configuration, the evaporated fuel processing device of the present invention can heat the absorber by the fuel that is heated by and discharged from the fuel pump.

The evaporated fuel processing device of the present invention may include recirculation piping that recirculates some of the fuel discharged from the fuel pump to an upstream side of the fuel pump.

With this configuration, the evaporated fuel processing device of the present invention recirculates some of the fuel that is heated by and discharged from the fuel pump to the upstream side of the fuel pump. Therefore, the absorber can be heated by the fuel that is repeatedly heated by the fuel pump.

A portion of an intake passage that suctions the fuel to the fuel pump may be formed in the absorber, and the recirculation piping may recirculate some of the fuel that is discharged from the fuel pump to the intake passage on an upstream side of the absorber.

With this configuration, the evaporated fuel processing device of the present invention recirculates some of the fuel that is heated by and discharged from the fuel pump to the upstream side of the fuel pump and let some of the fuel flow through the absorber. Therefore, the absorber can be heated by the fuel that is repeatedly heated by the fuel pump.

A portion of the recirculation piping may run through the absorber.

With this configuration, in the evaporated fuel processing device of the present invention, the recirculation piping by which some of the fuel that is heated by and discharged from the fuel pump is recirculated runs through the absorber. Therefore, the absorber can be heated by the fuel that is heated by the fuel pump.

The recirculation piping may be provided with a recirculation fuel adjustment mechanism that can adjust a flow rate of the fuel that is recirculated by the recirculation piping. The transferred heat amount control section may control the recirculation fuel adjustment mechanism so as to increase the flow rate of the fuel that is recirculated by the recirculation piping under a condition that the increase of the temperature of the absorber is requested by the temperature increase request section.

With this configuration, the evaporated fuel processing device of the present invention increases the flow rate of the fuel that is recirculated by the recirculation piping. Therefore, the amount of heat that is transferred from the fuel pump to the absorber can be increased.

A portion of a fuel supply passage that supplies the fuel from the fuel pump to the internal combustion engine may be formed in the absorber.

With this configuration, in the evaporated fuel processing device of the present invention, the portion of the fuel supply passage is formed by the absorber, and thus the heat is transferred when the fuel that is discharged from the fuel pump flows through the absorber. Therefore, the absorber can be heated.

The absorber may be in contact with the fuel pump.

With this configuration, in the evaporated fuel processing device of the present invention, the absorber is in contact with the fuel pump, and thus the heat is transferred from the fuel pump that is heated by being driven at a high driving voltage to the absorber. Therefore, the absorber can be heated.

The transferred heat amount control section may increase a driving force of the fuel pump and thereby increase the amount of heat that is transferred from the fuel pump to the absorber.

With this configuration, the evaporated fuel processing device of the present invention heats the fuel pump by increasing the driving force of the fuel pump and thereby increases the amount of heat that is transferred from the fuel pump to the absorber. Therefore, the absorber can be heated.

In the evaporated fuel processing device of the present invention, an internal tank may be provided in the fuel tank, and the internal tank may house the fuel pump and the absorber.

With this configuration, in the evaporated fuel processing device of the present invention, the fuel pump and the absorber are housed in the internal tank whose volume is smaller than the fuel tank. Therefore, the amount of heat that is transferred from the fuel pump to the absorber can efficiently be increased.

The temperature increase request section may request the increase of the temperature of the absorber either when the purge operation is executed by the purge mechanism or when the purge operation has been executed by the purge mechanism.

With this configuration, the evaporated fuel processing device of the present invention increases the temperature of the absorber either when the purge operation is executed or when the purge operation has been executed. Therefore, the desorbing performance of the absorber during the purge operation can be improved.

The temperature increase request section may request the increase of the temperature of the absorber under a condition that a load of the internal combustion engine becomes lower than a predetermined amount.

With this configuration, in the evaporated fuel processing device of the present invention, the temperature of the absorber is increased before the execution of the purge operation that is executed when the load of the internal combustion engine is low. Therefore, the desorbing performance of the absorber during the purge operation can be improved.

The temperature increase request section may request the increase of the temperature of the absorber under a condition that an outside air temperature becomes lower than a predetermined temperature.

With this configuration, in the evaporated fuel processing device of the present invention, the temperature of the absorber is increased in advance when the outside air temperature is low, such as in the winter or in a cold weather region. Therefore, the desorbing performance of the absorber during the purge operation can be improved.

The evaporated fuel processing device of the present invention may include a fuel pump control section that controls a driving voltage of the fuel pump to vary a discharging capacity in accordance with the load of the internal combustion engine. The temperature increase request section may not request the increase of the temperature of the absorber when the fuel pump is driven at a high driving voltage by the fuel pump control section.

With this configuration, the evaporated fuel processing device of the present invention does not request the increase of the temperature of the absorber when the fuel pump is driven at the high driving voltage and thus the amount of heat that is transferred from the fuel pump to the absorber has already been increased. Therefore, it is possible to prevent the fuel pump from being applied with more load than necessary.

The transferred heat amount control section may increase the driving voltage of the fuel pump in two stages and thereby increase the amount of heat that is transferred from the fuel pump to the absorber.

The evaporated fuel processing device of the present invention may include the recirculation piping that recirculates some of the fuel discharged from the fuel pump to the upstream side of the fuel pump. The recirculation piping may be provided with a recirculation fuel adjustment mechanism that can adjust the flow rate of the fuel that is recirculated by the recirculation piping. The transferred heat amount control section may control the recirculation fuel adjustment mechanism to increase the flow rate of the fuel that is recirculated by the recirculation piping under conditions that the increase of the temperature of the absorber is requested by the temperature increase request section and that the driving voltage of the fuel pump is increased by the one stage.

A fuel pressure in a delivery pipe that is provided in the internal combustion engine may become lower after the recirculation fuel adjustment mechanism controls to increase the flow rate of the fuel that is recirculated by the recirculation piping than before the recirculation fuel adjustment mechanism controls to increase the flow rate of the fuel that is recirculated by the recirculation piping.

The fuel pressure in the delivery pipe that is provided in the internal combustion engine may become higher after the recirculation fuel adjustment mechanism controls to increase the flow rate of the fuel that is recirculated by the recirculation piping and then the transferred heat amount control section controls to increase the driving voltage of the fuel pump by the two stages than before the recirculation fuel adjustment mechanism controls to increase the flow rate of the fuel that is recirculated by the recirculation piping.

A current that flows through the fuel pump may become lower after the recirculation fuel adjustment mechanism controls to increase the flow rate of the fuel that is recirculated by the recirculation piping than before the recirculation fuel adjustment mechanism controls to increase the flow rate of the fuel that is recirculated by the recirculation piping.

The current that flows through the fuel pump may become higher after the recirculation fuel adjustment mechanism controls to increase the flow rate of the fuel that is recirculated by the recirculation piping and then the transferred heat amount control section controls to increase the driving voltage of the fuel pump by the two stages than before the recirculation fuel adjustment mechanism controls to increase the flow rate of the fuel that is recirculated by the recirculation piping.

### Effect of the Invention

According to the present invention, it is possible to provide an evaporated fuel processing device that can sufficiently exert desorbing performance of an absorber in comparison with a conventional evaporated fuel processing device.

### BRIEF DESCRIPTION OF THE DRAWINGS

FIG. 1 is a schematic configuration view of a main section that includes an internal combustion engine for traveling and driving and a fuel system therefor in a vehicle in which an evaporated fuel processing device according to a first embodiment of the present invention is mounted.

FIG. 2 is a flowchart that illustrates a canister temperature increasing operation of the evaporated fuel processing device according to the first embodiment of the present invention.

FIG. 3 is a timing chart for illustrating an action of the canister temperature increasing operation of the evaporated fuel processing device according to the first embodiment of the present invention.

FIG. 4 is a schematic configuration view of a main section that includes an internal combustion engine for traveling and driving and a fuel system therefor in a vehicle in which an evaporated fuel processing device according to a second embodiment of the present invention is mounted.

FIG. 5 is a schematic configuration view of a main section that includes an internal combustion engine for traveling and driving and a fuel system therefor in a vehicle in which an evaporated fuel processing device according to a third embodiment of the present invention is mounted.

FIG. 6 is a schematic configuration view of a main section that includes an internal combustion engine for traveling and driving and a fuel system therefor in a vehicle in which an evaporated fuel processing device according to a fourth embodiment of the present invention is mounted.

FIG. 7 is a schematic configuration view of a main section that includes an internal combustion engine for traveling and driving and a fuel system therefor in a vehicle in which an evaporated fuel processing device according to a fifth embodiment of the present invention is mounted.

### MODES FOR CARRYING OUT THE INVENTION

A description will hereinafter be made on embodiments of an evaporated fuel processing device according to the present invention by using the drawings.

### First Embodiment

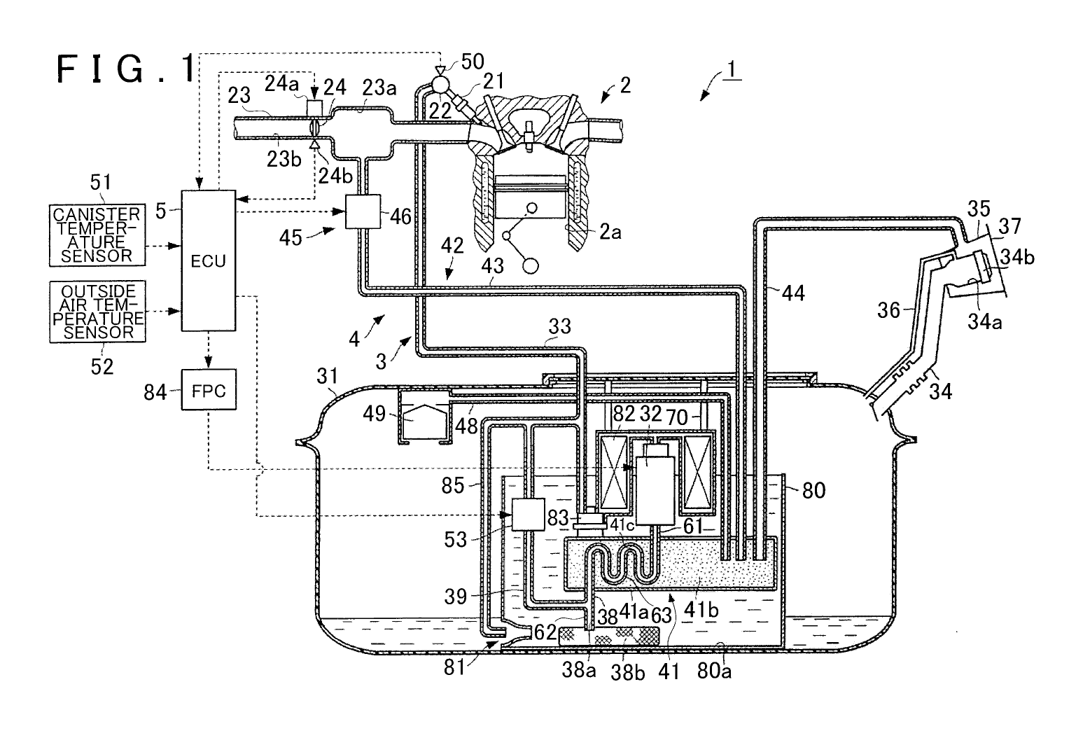

FIG. 1 shows a configuration of a main section of a vehicle in which an evaporated fuel processing device according to a first embodiment of the present invention is mounted, that is, mechanisms of an internal combustion engine for traveling and driving and a fuel system that supplies fuel and performs fuel purge. The internal combustion engine of this embodiment uses high-volatile fuel and is mounted in the unillustrated vehicle for a purpose of traveling and driving.

First, a configuration will be described.

As shown in FIG. 1, a vehicle 1 according to this embodiment is configured by including an engine 2, a fuel supply mechanism 3 that has a fuel tank 31, a fuel purge system 4 that constitutes the evaporated fuel processing device, and an electronic control unit (ECU) 5.

The engine 2 is constructed from a multicylinder internal combustion engine of spark ignition type, for example, an in-line four-cylinder four-stroke engine.

An injector 21 (a fuel injection valve) is attached to an intake port portion of each of four cylinders 2a (only one is shown in FIG. 1) of the engine 2. The plural injectors 21 are connected to a delivery pipe 22.

To the delivery pipe 22, high-volatile fuel (gasoline, for example) that is pressurized to have fuel pressure (fuel pressure) requested for the engine 2 is supplied from a fuel pump 32, which will be described below.

In addition, an intake pipe 23 is connected to the intake port portion of the engine 2, and this intake pipe 23 is provided with a surge tank 23a that has a specified volume and that suppresses intake pulsation and intake interference.

An intake passage 23b is formed in the intake pipe 23, and a throttle valve 24 is provided on the intake passage 23b. The throttle valve 24 is driven by a throttle actuator 24a in a manner that it can adjust an opening degree. This throttle valve 24 adjusts an intake air amount that is suctioned into the engine 2 by adjusting an opening degree of the intake passage 23b.

The fuel supply mechanism 3 is configured by including the fuel tank 31, an internal tank 80 mounted in the fuel tank 31, the fuel pump 32, a fuel supply pipe 33 that connects the delivery pipe 22 and the fuel pump 32, and intake piping 38 that is provided on an upstream side of the fuel pump 32. Noted that the fuel pump 32 is housed in the fuel tank 31 in FIG. 1. However, the fuel pump 32 needs not be housed in the fuel tank 31 in the present invention.

The fuel tank 31 is arranged in a lower portion side of a vehicle body of the vehicle 1 and stores the fuel that is consumed by the engine 2 in a manner that it can be refueled. The internal tank 80 is formed to have a substantially cylindrical bottomed shape and provided in the fuel tank 31.

The internal tank 80 can store the fuel therein. More specifically, the internal tank 80 is provided with a jet pump 81 that suctions the fuel in the fuel tank 31 into the internal tank 80. The jet pump 81 suctions the fuel into the internal tank 80 in accordance with actuation of the fuel pump 32.

The shape of the internal tank 80 is not limited to the cylindrical shape but may be a square cylinder shape or a box shape. The shape thereof is not particularly limited. In addition to the fuel pump 32, a canister 41, a suction filter 38b, a fuel filter 82, and a pressure regulator 83 are housed in the internal tank 80.

The fuel pump 32 is of a type that exerts a variable discharging capacity (a discharge amount and discharge pressure) with which the fuel pump 32 can pump up the fuel in the fuel tank 31 and pressurizes the fuel to have the same or higher fuel pressure than specified feeding fuel pressure, and is constructed from a circumferential flow pump, for example. Although the detailed internal configuration of this fuel pump 32 is not shown, the fuel pump 32 has an impeller for actuating the pump and a built-in motor for driving the impeller.

In addition, the fuel pump 32 changes at least one of a rotational speed and rotational torque of the impeller for actuating the pump in accordance with a driving voltage and load torque of the built-in motor, and can thereby change the discharging capacity per unit time.

In order to change the discharging capacity of the fuel pump 32 as described above, the fuel supply mechanism 3 is provided with a fuel pump controller (FPC) 84 for controlling a driving force, that is, the driving voltage of the fuel pump 32 in accordance with control by the ECU 5.

A housing of the fuel filter 82 is held by a holding mechanism 70 in an integrated manner with the fuel pump 32 in the internal tank 80. The fuel filter 82 filters the fuel that is discharged from the fuel pump 32. In this embodiment, the fuel filter 82 is a known filter in which the housing is formed to surround the fuel pump 32 and that filters the fuel discharged from the fuel pump 32.

The pressure regulator 83 is constructed from a valve of constantly closed type for an emergency purpose that is provided on a downstream side of the fuel filter 82. The pressure regulator 83 opens when the fuel pressure in the fuel filter 82 becomes equal to or higher than predetermined fuel pressure, and returns the excess fuel to the internal tank 80.

The fuel supply pipe 33 forms a fuel supply passage that mutually communicates an output port of the pressure regulator 83 and the delivery pipe 22. Pilot piping 85 is connected to the fuel supply pipe 33, the pilot piping 85 providing a driving flow to the jet pump 81 by recirculating at least some of the fuel, which is discharged from the fuel pump 32, in the fuel tank 31.

Noted that the pilot piping 85 and the fuel supply pipe 33 are shown as substantially the equivalent piping to each other in FIG. 1. However, in accordance with a setting ratio of a maximum flow rate of the fuel in the pilot piping 85 to a maximum flow rate of the fuel in the fuel supply pipe 33, cross-sectional areas of passages in the pilot piping 85 and the fuel supply pipe 33 may differ from each other, or an appropriate restrictor may be provided to each of the pilot piping 85 and the fuel supply pipe 33.

The intake piping 38 is formed with an intake passage 38a on an upstream side of the fuel pump 32. The suction filter 38b is provided on the most upstream portion of the intake passage 38a. This suction filter 38b is a known filter that filters the fuel suctioned into the fuel pump 32.

Meanwhile, the fuel tank 31 is provided with a feeding pipe 34 that is projected to extend from the fuel tank 31 to a lateral side or a rear side of the vehicle 1. A feeding opening 34a is formed at a tip of the feeding pipe 34 in a projected direction. This feeding opening 34a is housed in a fuel inlet box 35 that is provided in an unillustrated body of the vehicle 1.

In addition, the feeding pipe 34 is provided with circulation piping 36 that communicates between an upper portion of the fuel tank 31 and an upstream portion of the inside of the feeding pipe 34. The fuel inlet box 35 is provided with a fuel lid 37 that is opened externally during feeding of the fuel.

During the feeding of the fuel, the fuel lid 37 is opened, and a cap 34b that is attached to the feeding opening 34a in a removable manner is removed. The fuel can thereby be poured into the fuel tank 31 from the feeding opening 34a.

The fuel purge system 4 is interposed between the fuel tank 31 and the intake pipe 23, in detail, between the fuel tank 31 and the surge tank 23a. The fuel purge system 4 can release and evaporated fuel, which is generated in the fuel tank 31, to the intake passage 23b and combust the fuel during an intake stroke of the engine 2.

The fuel purge system 4 is configured by including: the canister 41 (the absorber) that absorbs the evaporated fuel, which is generated in the fuel tank 31; a purge mechanism 42 for carrying out a purge operation in which the air flows through the canister 41 and purge gas is suctioned into the intake pipe 23 of the engine 2, the purge gas containing the fuel desorbed from the canister 41 and the air; and a purge control mechanism 45 that controls an intake amount of the purge gas in the intake pipe 23, so as to suppress fluctuations of the air-fuel ratio in the engine 2.

The canister 41 includes an absorbent 41b such as activated carbon in a canister case 41a, and is mounted in the internal tank 80 in a manner to be separated from an inner bottom surface 80a thereof. The inside (an absorber housing space) of this canister 41 communicates with an upper space in the fuel tank 31 via an evaporation piping 48 and a gas-liquid separation valve 49.

Accordingly, the canister 41 can absorb the evaporated fuel by the absorbent 41b when the fuel in the fuel tank 31 is evaporated and the evaporated fuel is collected in the upper space in the fuel tank 31. In addition, during elevation of a liquid surface or fluctuations in the liquid surface of the fuel in the fuel tank 31, the gas-liquid separation valve 49, which functions as a check valve, rises to close a tip of the evaporation piping 48.

The purge mechanism 42 has: purge piping 43 that communicates the inside of the canister 41 with an inner portion of the surge tank 23a in the intake passage 23b of the intake pipe 23; and atmosphere piping 44 by which the inside of the canister 41 is opened to the atmospheric side, for example, an atmospheric pressure space in the fuel inlet box 35.

When a negative pressure is generated in the surge tank 23a during an operation of the engine 2, this purge mechanism 42 can introduce the negative pressure to one end side in the canister 41 through the purge piping 43 and can also introduce the atmospheric air to another end side in the canister 41 through the atmosphere piping 44.

Accordingly, the purge mechanism 42 can desorb (release) the fuel that has been absorbed by the absorbent 41b of the canister 41 and held in the canister 41 from the canister 41 and suction the fuel in the surge tank 23a.

The purge control mechanism 45 is configured by including a vacuum solenoid valve (hereinafter referred to as a “purge VSV”) 46 for purging that is controlled by the ECU 5.

The purge VSV 46 is provided in the middle of the purge piping 43. This purge VSV 46 can variably control an amount of the fuel that is desorbed from the canister 41 by changing an opening degree in the middle of the purge piping 43.

More specifically, the purge VSV 46 can change the opening degree when excitation current thereof is subjected to duty control, can handle the fuel that has been desorbed from the canister 41 by the intake negative pressure in the intake pipe 23 and the air as the purge gas, and can suction the purge gas into the surge tank 23a at a purge rate that corresponds to a duty ratio.

In this embodiment, it is configured that a portion of the intake piping 38, which connects the suction filter 38b and the fuel pump 32, runs through the canister 41.

More specifically, the intake piping 38 is configured by including a pump side connection section 61 that is connected to an intake port of the fuel pump 32, a filter side connection section 62 that is connected to the suction filter 38b, and a heat transfer pipe section 63 that is located between these pump side connection section 61 and filter side connection section 62.

Especially, the heat transfer pipe section 63 is arranged in the canister 41. The heat transfer pipe section 63 has a meandering shape, for example, in the canister 41. Accordingly, a large contact area can be obtained between the fuel that is suctioned into the fuel pump 32 and the absorbent 41b of the canister 41 that has absorbed the fuel, and thus a large heat transfer amount can be obtained.

Noted that the shape of the heat transfer pipe section 63 is not limited to the meandering shape but can be any shape as long as the large contact area with the absorbent 41b can be obtained. Any of various types of shapes can be adopted, such as a shape in which the heat transfer pipe section 63 is branched into plural passages in the absorbent 41b and these plural passages are arranged in parallel, and a spiral shape.

Here, the heat transfer pipe section 63 of the intake piping 38 is integrally coupled to the canister case 41a, and a heat transfer surface 41c that is an inner wall surface of an inner passage of the canister 41 is formed by an inner wall surface of the heat transfer pipe section 63.

This heat transfer surface 41c can guide the fuel that flows through the fuel tank 31 during the actuation of the fuel pump 32, particularly the fuel that is suctioned into the fuel pump 32 in an intake direction. In addition, the heat transfer surface 41c allows heat transfer between the canister 41 and the fuel on an intake side that flows in a direction to be suctioned into the fuel pump 32 among the fuel in the fuel tank 31.

In other words, the heat transfer pipe section 63 allows the favorable heat transfer in the heat transfer surface 41c when there is a temperature difference between the fuel on the intake side and the canister 41. In addition, the heat transfer pipe section 63 is formed of a metallic material having high thermal conductivity or the like that can favorably transfer the heat from the heat transfer pipe section 63 to the absorbent 41b that has absorbed the fuel.

Recirculation piping 39 is connected between the fuel supply pipe 33 and the intake piping 38, the recirculation piping 39 recirculating the fuel that is discharged from the fuel pump 32, in detail, the fuel that is discharged from the fuel pump 32 but is not supplied to the fuel supply pipe 33 or the pilot piping 85 to the intake passage 38a that is on the upstream side of the canister 41 in the fuel tank 31.

More specifically, the recirculation piping 39 is arranged in the fuel tank 31. An end of the recirculation piping 39 on an upstream side in a recirculating direction is branched from the fuel supply pipe 33, and an end of the recirculation piping 39 on a downstream side in the recirculating direction is connected to the filter side connection section 62 of the intake piping 38.

This recirculation piping 39 is configured to enable recirculation of the fuel that is discharged by the fuel pump 32 to the intake side of the fuel pump 32 in the fuel tank 31. In this embodiment, the recirculation piping 39 recirculates the fuel that is discharged from the fuel pump 32 into the intake passage 38a that is on the upstream side of the canister 41.

Noted that the intake passage that is referred in the present invention includes the intake passage 38a, which is formed on the inside of the intake piping 38, and a passage portion on the inside of the suction filter 38b that integrally communicates with this intake passage 38a (hereinafter, both of the components are also referred to as “the intake passage 38a and the like”).

In other words, the intake passage is divided from the suction filter 38b and a fuel storage region around the intake piping 38 by being surrounded by the suction filter 38b and the intake piping 38. The intake passage is a passage that can suction the fuel into an intake port section 32a of the fuel pump 32 through the suction filter 38b and that can guide the fuel that has passed through the suction filter 38b in the intake direction.

Noted that the recirculation piping 39 and the fuel supply pipe 33 are shown as substantially the equivalent piping to each other in FIG. 1. However, in accordance with the setting ratio of a maximum flow rate of the fuel in the recirculation piping 39 to the maximum flow rate of the fuel in the fuel supply pipe 33, cross-sectional areas of passages in the recirculation piping 39 and the fuel supply pipe 33 can differ from each other, or the appropriate restrictor can be provided to each of the recirculation piping 39 and the fuel supply pipe 33.

The recirculation piping 39 is provided with an on-off valve 53. The on-off valve 53 is of constantly closed type that is switched to an opened state on the basis of a valve opening signal from the ECU 5. More specifically, the on-off valve 53 is constructed by a known electromagnetic valve of the constantly closed type that constantly urges a valve body to a valve closing side by an urging member such as a compression spring and that urges the valve body in a valve opening direction by exciting an electromagnetic solenoid in accordance with the valve opening signal from the ECU 5.

Noted that the on-off valve 53 may be of the constantly closed type that is switched to a closed state on the basis of a valve closing signal from the ECU 5. In the present invention, the on-off valve 53 constitutes a recirculation fuel adjustment mechanism that can adjust a flow rate of the fuel that is recirculated by the recirculation piping 39.

The ECU 5 is constructed by a microprocessor that includes a central processing unit (CPU), a read only memory (RAM), a random access memory (RAM), a flash memory, and an input/output port, which are not shown.

The ROM of the ECU 5 stores a program that allows the microprocessor to function as the ECU 5. In other words, the CPU of the ECU 5 uses the RAM as a workspace and executes the program stored in the ROM. The microprocessor thereby functions as the ECU 5.

Various types of sensors including a fuel pressure sensor 50 for detecting fuel pressure in the delivery pipe 22, a canister temperature sensor 51, and an outside air temperature sensor 52 are connected to an input side of the input/output port of the ECU 5.

The canister temperature sensor 51 is arranged in a joined portion between the canister 41 and the purge piping 43, that is, in the vicinity of a purge port of the canister 41, for example. The canister temperature sensor 51 detects a temperature on the inside of the canister 41 (hereinafter referred to as a “canister internal temperature Tc”) in the vicinity of the purge port. The canister temperature sensor 51 sends a detection signal that indicates the detected canister internal temperature Tc to the ECU 5.

In addition, various types of control objects, such as the throttle actuator 24a, the purge VSV 46, the on-off valve 53, and the FPC 84, are connected to an output side of the input/output port of the ECU 5.

In this embodiment, the ECU 5 changes the driving voltage of the fuel pump 32 via the FPC 84 in accordance with an engine speed and a load that are requested to the engine 2 on the basis of a map that is stored in the ROM or the like in advance, so as to switch the inside of the delivery pipe 22 to a low fuel pressure state or a high fuel pressure state. Just as described, the ECU 5 and the FPC 84 constitute a fuel pump control section in the present invention.

More specifically, the ECU 5 sets the inside of the delivery pipe 22 in the low fuel pressure state during normal traveling and sets the inside of the delivery pipe 22 in the high fuel pressure state when the engine speed and the load that are requested to the engine 2 are relatively high.

For example, when the inside of the delivery pipe 22 is brought into the low fuel pressure state (for example, 300 kPa), the ECU 5 controls the FPC 84 to set the driving voltage of the built-in motor in the fuel pump 32 (hereinafter simply referred to as the “driving voltage of the fuel pump 32”) to a specified low driving voltage (for example, 6 V). In this case, a current of 3 A flows through the built-in motor of the fuel pump 32.

Meanwhile, when the inside of the delivery pipe 22 is brought into the high fuel pressure state (for example, 600 kPa), the ECU 5 controls the FPC 84 to set the driving voltage of the fuel pump 32 to a specified high driving voltage (for example, 12 V). In this case, a current of 8 A flows through the built-in motor of the fuel pump 32.

The ECU 5 brings the purge VSV 46 under the duty control on the basis of various types of sensor information and thus can control the purge rate. For example, when the engine 2 is in a specified operation state, the ECU 5 opens the purge VSV 46 under a condition that the opening degree of the throttle valve 24 obtained by a throttle opening degree sensor 24b becomes smaller than a set opening degree that is set in advance. In this way, the ECU 5 lets the purge mechanism 42 to execute the purge operation.

In addition, the ECU 5 executes a canister temperature increasing operation by which the internal temperature of the canister 41 is increased either when the ECU 5 lets the purge mechanism 42 to execute the purge operation or when the ECU 5 has let the purge mechanism 42 to execute the purge operation. Just as described, the ECU 5 constitutes a temperature increase request section of the present invention.

For example, in a case where the driving voltage of the fuel pump 32 is the low driving voltage when the vehicle 1 is in a state that execution of the purge operation or preparation of the purge operation by the purge mechanism 42 is requested and when the internal temperature Tc of the canister 41 that is detected by the canister temperature sensor 51 is lower than a specified temperature To, the ECU 5 controls the FPC 84, increases the driving voltage of the fuel pump 32 to a high driving voltage, and opens the on-off valve 53.

The ECU 5 controls the FPC 84 and thereby controls the driving voltage of the fuel pump 32. In the canister temperature increasing operation, the ECU 5 increases the heat amount that is transferred from the fuel pump 32 to the canister 41.

Specifically, in the canister temperature increasing operation, the ECU 5 increases the heat amount that is transferred from the fuel pump 32 to the canister 41 via the fuel. More specifically, in the canister temperature increasing operation, the ECU 5 increases the heat amount that is transferred from the fuel pump 32 to the canister 41 via the fuel that is discharged from the fuel pump 32.

For example, in the canister temperature increasing operation, when the internal temperature Tc of the canister 41 is lower than the specified temperature To and the driving voltage of the fuel pump 32 is the low driving voltage, the ECU 5 controls the FPC 84 and sets the driving voltage of the fuel pump 32 to the high driving voltage. Just as described, the ECU 5 and the FPC 84 constitute a transferred heat amount control section in the present invention.

In addition, the ECU 5 controls opening and closing of the on-off valve 53. More specifically, the ECU 5 opens the on-off valve 53 during the execution of the canister temperature increasing operation, and closes the on-off valve 53 when the canister temperature increasing operation is terminated.

Here, the ECU 5 allows opening of the on-off valve 53 under a condition that the internal temperature Tc of the canister 41 detected by the canister temperature sensor 51 is lower than a predetermined specified temperature (hereinafter referred to as the “specified temperature To”).

When the on-off valve 53 is opened by the ECU 5, the fuel in the intake side of the fuel pump 32, particularly the fuel in the suction filter 38b and the intake piping 38 joins the fuel that is discharged from the fuel pump 32 and recirculated to the intake side through the recirculation piping 39, and thus contains the fuel that is discharged from the fuel pump 32 and the fuel that is newly suctioned from the outside of the intake passage through the suction filter 38b.

As described above, when the fuel that is discharged from the fuel pump 32 is recirculated to the intake side of the fuel pump 32 in the fuel tank 31 through the recirculation piping 39, the heat transfer surface 41c of the canister 41 allows the heat transfer between the canister 41 and the fuel in the intake piping 38 and the suction filter 38b that contains the fuel discharged from the fuel pump 32 and that flows in the direction to be suctioned into the fuel pump 32 among the fuel in the fuel tank 31.

Noted that, in this embodiment, the ECU 5 controls the on-off valve 53 and the FPC 84 in accordance with the internal temperature of the canister 41 that is detected in the vicinity of the purge port of the canister 41 by the canister temperature sensor 51. However, the ECU 5 may control the on-off valve 53 and the FPC 84 in accordance with an internal pressure of the canister 41, for example, an internal pressure of the canister 41 before initiation of the purge.

In this case, an internal pressure sensor that is substituted for the canister temperature sensor 51 detects a pressure on the inside of the canister 41 (hereinafter referred to as a “canister internal pressure Pc”) in the vicinity of the purge port of the canister 41.

Furthermore, when the vehicle 1 is in the state that the execution of the purge operation or the preparation of the purge operation by the purge mechanism 42 is requested, and when the internal pressure Pc of the canister 41, which is detected by the internal pressure sensor, is lower than a predetermined specified pressure Po, the ECU 5 is configured to control the FPC 64 so as to control the driving voltage of the fuel pump 32 and to open the on-off valve 53.

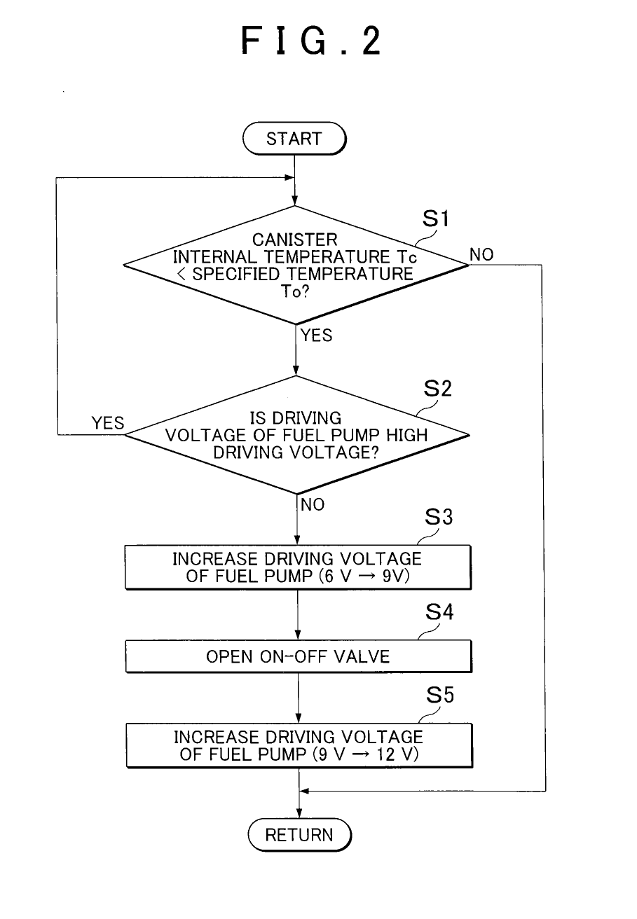

Next, a description will be made on the canister temperature increasing operation by the evaporated fuel processing device according to this embodiment with reference to a flowchart in FIG. 2. As described above, the canister temperature increasing operation, which will be described below, is started when the vehicle 1 is brought into the state that the execution of the purge operation or the preparation of the purge operation by the purge mechanism 42 is requested.

First, the ECU 5 determines whether the internal temperature Tc of the canister 41, which is detected by the canister temperature sensor 51, is lower than the specified temperature To (step S1). Here, if it is determined that the internal temperature Tc of the canister 41 is lower than the specified temperature To, the ECU 5 determines whether the driving voltage of the fuel pump 32 is the high driving voltage (step S2).

Here, if it is determined that the driving voltage of the fuel pump 32 is not the high driving voltage, the ECU 5 controls the FPC 84 and, for example, increases the driving voltage of the fuel pump 32 from 6 V to 9 V (step S3).

Next, the ECU 5 opens the on-off valve 53 (step S4), controls the FPC 84, for example, increases the driving voltage of the fuel pump 32 from 9 V to 12 V (step S5), and returns the canister temperature increasing operation to step S1.

If it is determined in step S2 that the driving voltage of the fuel pump 32 is the high driving voltage, the ECU 5 returns the canister temperature increasing operation to step S1. In addition, if it is determined in step S1 that the internal temperature Tc of the canister 41 is equal to or higher than the specified temperature To, the ECU 5 terminates the canister temperature increasing operation.

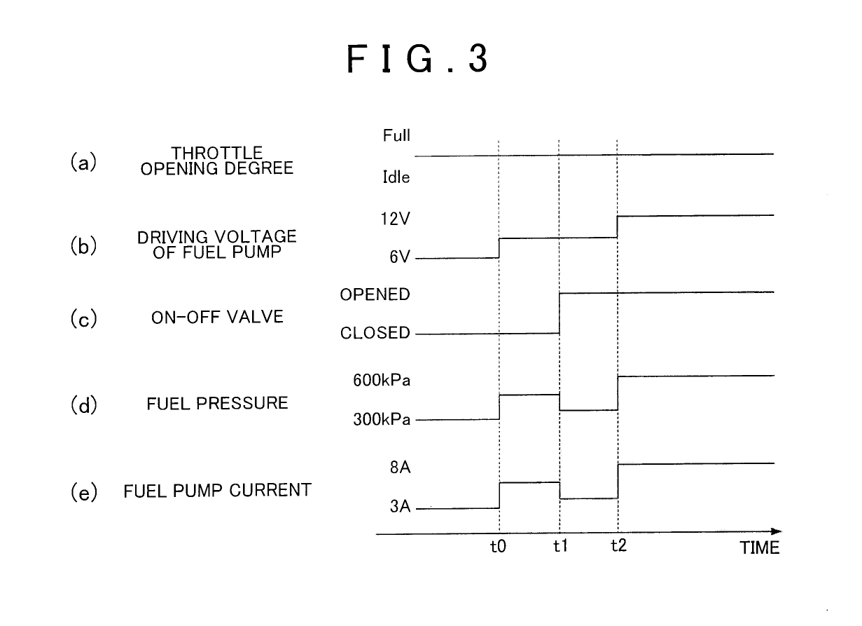

Next, a description will be made on an action of the canister temperature increasing operation of the evaporated fuel processing device according to this embodiment with reference to a timing chart in FIG. 3. Noted that FIG. 3 illustrates timing of each component when the vehicle 1 is brought into the operation state that the execution of the purge operation or the preparation of the purge operation by the purge mechanism 42 is requested, when the internal temperature Tc of the canister 41 is lower than the specified temperature To, and when the driving voltage of the fuel pump 32 is in a state of the low driving voltage (6 V) onward. In addition, as shown in (a) of FIG. 3, a throttle opening degree remains substantially constant.

First, at time t0, as shown in (b), the ECU 5 controls the FPC 84, and, for example, increases driving voltage of the fuel pump 32 from 6 V to 9 V. Accordingly, as shown in (d) and (e), respectively, the fuel pressure and the current that flows through the built-in motor of the fuel pump 32 (hereinafter referred to as a “fuel pump current”) are increased.

At time t1, the ECU 5 opens the on-off valve 53. Accordingly, as shown in (d), the fuel pressure is reduced, and, in conjunction with reduction in the fuel pressure, the fuel pump current is also reduced as shown in (e).

At time t2, the FPC 84 is controls to, for example, increase the driving voltage of the fuel pump 32 from 9 V to 12 V. Accordingly, as shown in (d) and (e), respectively, the fuel pressure and the fuel pump current are also increased.

Since the fuel pump current is increased as described above, the fuel that is discharged from the fuel pump 32 is heated. Then, the heated fuel is recirculated to the internal tank 80 by the recirculation piping 39. As a result, the canister 41 is heated by the fuel that is heated by the fuel pump 32 and recirculated to the internal tank 80.

As it has been described so far, in this embodiment, the pressure of the fuel that is discharged by the fuel pump 32 is increased, and the current that flows through the fuel pump 32 is thereby increased. Accordingly, the fuel that is discharged from the fuel pump 32 is heated, and the canister 41 is further heated by the heated fuel. Thus, in comparison with the conventional evaporated fuel processing device, the evaporated fuel processing device of this embodiment can sufficiently exert desorbing performance of the canister 41.

Noted that it is described in this embodiment that the ECU 5 executes the canister temperature increasing operation before the ECU 5 lets the purge mechanism 42 to execute the purge operation. However, in the present invention, the canister temperature increasing operation may be executed under a condition that the load of the engine 2 is reduced to a predetermined load amount.

With such a configuration, the ECU 5 increases the temperature of the canister 41 before the purge operation that is executed when the load of the engine 2 is low. Accordingly, the desorbing performance of the canister 41 during the purge operation can be improved.

In addition, in the present invention, the ECU 5 may execute the canister temperature increasing operation under a condition that the outside air temperature detected by the outside air temperature sensor 52 becomes lower than a predetermined temperature at which a fuel desorbing property by the absorbent 41b is degraded.

With such a configuration, the ECU 5 increases the canister 41 in advance when the outside air temperature is low in the winter, in a cold weather region, or the like. Accordingly, the desorbing performance of the canister 41 during the purge operation can be improved.

### Second Embodiment

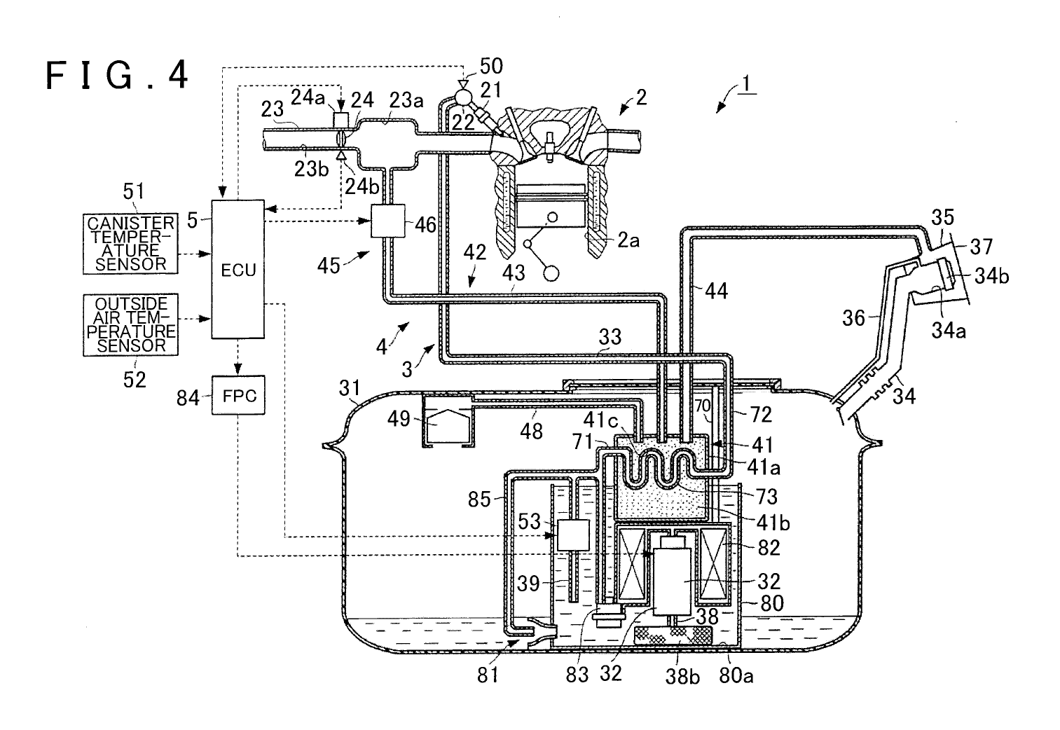

FIG. 4 shows a configuration of a main section of a vehicle in which an evaporated fuel processing device according to a second embodiment of the present invention is mounted, that is, mechanisms of an internal combustion engine for traveling and driving and a fuel system that supplies fuel and performs fuel purge.

In this embodiment, although the configurations of the canister and the vicinity thereof differ from those in the first embodiment, the configurations of the other main components are the same as those of the first embodiment. Thus, the same components as those in the first embodiment are denoted by the same reference numerals, and the following description will be made on differences from the first embodiment.

In the first embodiment of the present invention, it is configured that the portion of the intake piping 38 that connects the suction filter 38b and the fuel pump 32 runs through the inside of the canister 41. Meanwhile, in this embodiment, it is configured that a portion of the fuel supply pipe 33 that connects the pressure regulator 83 and the delivery pipe 22 runs through the inside of the canister 41.

More specifically, the fuel supply pipe 33 is configured by including a regulator side connection section 71 that is connected to the output port of the pressure regulator 83, a delivery pipe side connection section 72 that is connected to the delivery pipe 22, and a heat transfer pipe section 73 that is located between these regulator side connection section 71 and delivery pipe side connection section 72.

Particularly, the heat transfer pipe section 73 is arranged in the canister 41. The heat transfer pipe section 73 has a meandering shape, for example, in the canister 41. Accordingly, a large contact area can be obtained between the fuel that is discharged from the fuel pump 32 and the absorbent 41b of the canister 41 that has absorbed the fuel, and thus a large heat transfer amount can be obtained.

Noted that the shape of the heat transfer pipe section 73 is not limited to the meandering shape but can be any shape as long as the large contact area with the absorbent 41b can be obtained. Any of various types of shapes can be adopted, such as a shape in which the heat transfer pipe section 73 is branched into plural passages in the absorbent 41b and these plural passages are arranged in parallel, and a spiral shape.

Here, the heat transfer pipe section 73 of the fuel supply pipe 33 is integrally coupled to the canister case 41a, and the heat transfer surface 41c that is the inner wall surface of the inner passage of the canister 41 is formed by an inner wall surface of the heat transfer pipe section 73.

This heat transfer surface 41c can guide the fuel that flows through the fuel tank 31 during the actuation of the fuel pump 32, particularly, the fuel that is discharged from the fuel pump 32 to the delivery pipe 22. In addition, the heat transfer surface 41c allows the heat transfer between the canister 41 and the fuel that flows in a direction to be discharged from the fuel pump 32 among the fuel in the fuel tank 31.

In other words, the heat transfer pipe section 73 allows the favorable heat transfer in the heat transfer surface 41c when there is the temperature difference between the fuel on the intake side and the canister 41. In addition, the heat transfer pipe section 73 is formed of a metallic material having high thermal conductivity or the like that can favorably transfer the heat from the heat transfer pipe section 73 to the absorbent 41b that has absorbed the fuel.

In addition, the end of the recirculation piping 39 on the downstream side in the recirculating direction in the first embodiment of the present invention is connected to the intake piping 38. However, in the recirculation piping 39 of this embodiment, the end on the downstream side in the recirculating direction is opened to the inner bottom surface 80a of the internal tank 80.

Accordingly, the recirculation piping 39 can recirculate the fuel that is discharged by the fuel pump 32, in detail, the fuel that is discharged from the fuel pump 32 but is not supplied to the fuel supply pipe 33 or the pilot piping 85 to a periphery of the suction filter 38b that is provided in the vicinity of the inner bottom surface 80a of the internal tank 80.

As for the canister temperature increasing operation by the ECU 5 in this embodiment, it is the same as the canister temperature increasing operation by the ECU 5 in the first embodiment of the present invention. Thus, the description thereof will not be repeated.

As it has been described so far, the same effects as those obtained by the first embodiment of the present invention can be obtained by this embodiment. Particularly, the portion of the fuel supply passage is formed by the canister 41 in this embodiment. Accordingly, the heat is transferred when the fuel that is discharged from the fuel pump 32 flows through the canister 41, and the canister 41 is thereby heated. Thus, the desorbing performance of the canister 41 during the purge operation can be improved.

### Third Embodiment

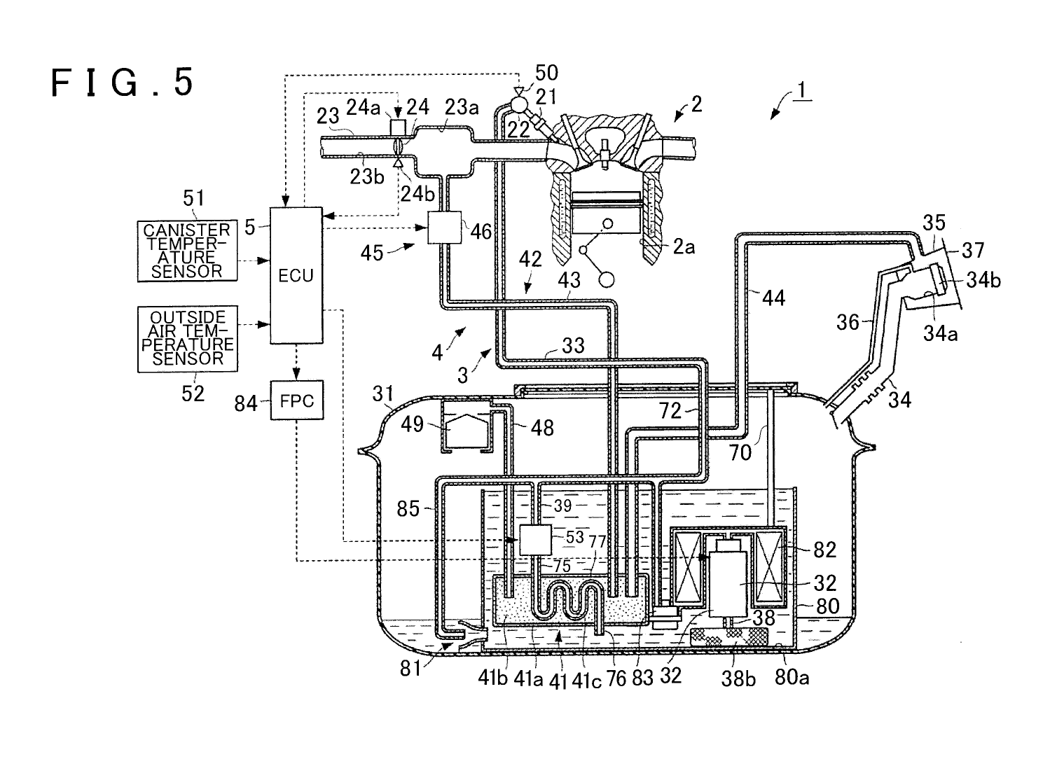

FIG. 5 shows a configuration of a main section of a vehicle in which an evaporated fuel processing device according to a third embodiment of the present invention is mounted, that is, mechanisms of an internal combustion engine for traveling and driving and a fuel system that supplies fuel and performs fuel purge.

In this embodiment, although the configurations of the canister and the vicinity thereof differ from those in the first embodiment, the configurations of the other main components are the same as those of the first embodiment. Thus, the same components as those in the first embodiment are denoted by the same reference numerals, and the following description will be made on differences from the first embodiment.

In this embodiment, the end side of the recirculation piping 39 that is in the vicinity of the discharge side of the fuel pump 32 is branched from the fuel supply pipe 33, and the other side thereof is opened downward near an inner bottom section of the fuel tank 31.

In addition, it is configured that a portion of the recirculation piping 39 runs through the inside of the canister 41. More specifically, the recirculation piping 39 is configured by including a pump side connection section 75 that is connected to the fuel supply pipe 33, an opened section 76 on an opened side, and a heat transfer pipe section 77 that is located between these pump side connection section 75 and opened section 76.

Particularly, the heat transfer pipe section 77 is arranged in the canister 41. The heat transfer pipe section 63 has the meandering shape, for example, in the canister 41. Accordingly, a large contact area can be obtained between the fuel that is suctioned into the fuel pump 32 and the absorbent 41b of the canister 41 that has absorbed the fuel, and thus a large heat transfer amount can be obtained.

Noted that the shape of the heat transfer pipe section 77 is not limited to the meandering shape but can be any shape as long as the large contact area with the absorbent 41b can be obtained. Any of various types of shapes can be adopted, such as a shape in which the heat transfer pipe section 77 is branched into plural passages in the absorbent 41b and these plural passages are arranged in parallel, and a spiral shape.

Here, the heat transfer pipe section 77 of the recirculation piping 39 is integrally coupled to the canister case 41a, and the heat transfer surface 41c that is the inner wall surface of the inner passage of the canister 41 is formed by an inner wall surface of the heat transfer pipe section 77.

This heat transfer surface 41c can guide the fuel that flows through the fuel tank 31 during the actuation of the fuel pump 32, particularly, the fuel that is discharged from the fuel pump 32 into the fuel tank 31. In addition, the heat transfer surface 41c allows the heat transfer between the canister 41 and the fuel that flows in the direction to be discharged from the fuel pump 32.

In other words, the heat transfer pipe section 77 allows the favorable heat transfer in the heat transfer surface 41c when there is the temperature difference between the fuel on the discharge side and the canister 41. In addition, the heat transfer pipe section 77 is formed of a metallic material having high thermal conductivity or the like that can favorably transfer the heat from the heat transfer pipe section 77 to the absorbent 41b that has absorbed the fuel.

As for the canister temperature increasing operation by the ECU 5 in this embodiment, it is the same as the canister temperature increasing operation by the ECU 5 in the first embodiment of the present invention. Thus, the description thereof will not be repeated.

As it has been described so far, the same effects as those obtained by the first embodiment of the present invention can be obtained by this embodiment. Particularly, the portion of the recirculation passage is formed by the canister 41 in this embodiment. Accordingly, the heat is transferred when the fuel that is discharged from the fuel pump 32 and recirculated into the recirculation piping 39 flows through the canister 41. The canister 41 can thereby be heated.

### Fourth Embodiment

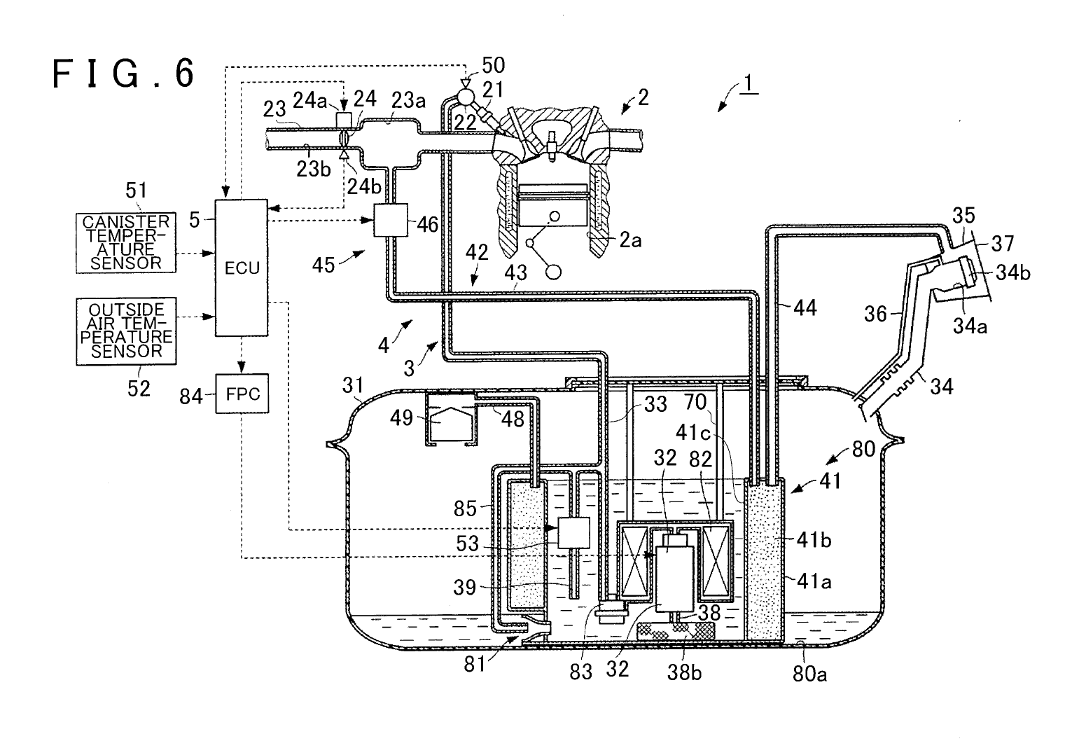

FIG. 6 shows a configuration of a main section of a vehicle in which an evaporated fuel processing device according to a fourth embodiment of the present invention is mounted, that is, mechanisms of an internal combustion engine for traveling and driving and a fuel system that supplies fuel and performs fuel purge.

In this embodiment, although the configurations of the canister and the vicinity thereof differ from those in the first embodiment, the configurations of the other main components are the same as those of the first embodiment. Thus, the same components as those in the first embodiment are denoted by the same reference numerals, and the following description will be made on differences from the first embodiment.

In this embodiment, the canister 41 in the first embodiment of the present invention constitutes the internal tank 80. The internal tank 80, that is, the canister 41 is formed in the substantially cylindrical bottomed shape and provided in the fuel tank 31.

In the canister 41, the fuel can be stored in the cylinder. More specifically, the canister 41 is provided with the jet pump 81 that suctions the fuel in the fuel tank 31 into the cylinder that is formed by the canister 41. The intake amount of the jet pump 81 varies in accordance with an actuation amount of the fuel pump 32.

The shape of the canister 41 is not limited to the cylinder but may be a square cylinder or a box. The shape thereof is not particularly limited. The fuel pump 32, the suction filter 38b, the fuel filter 82, and the pressure regulator 83 are housed in the cylinder that is formed by the canister 41.

Here, an inner surface of the cylinder that is formed by the canister 41 forms the heat transfer surface 41c. This heat transfer surface 41c can guide the fuel that flows through the fuel tank 31 during the actuation of the fuel pump 32, particularly, the fuel that is discharged from the fuel pump 32 in the intake direction.

In addition, the heat transfer surface 41c allows the heat transfer between the canister 41 and the fuel that flows in the direction to be discharged from the fuel pump 32 among the fuel in the fuel tank 31.

In other words, the heat transfer surface 41c allows the favorable heat transfer when there is the temperature difference between the fuel on the intake side and the canister 41. In addition, the heat transfer surface 41c is formed of a metallic material having high thermal conductivity or the like that can favorably transfer the heat to the absorbent 41b that has absorbed the fuel.

As for the canister temperature increasing operation by the ECU 5 in this embodiment, it is the same as the canister temperature increasing operation by the ECU 5 in the first embodiment of the present invention. Thus, the description thereof will not be repeated.

As it has been described so far, the same effects as those obtained by the first embodiment of the present invention can be obtained by this embodiment. Particularly, in this embodiment, the fuel that is discharged from the fuel pump 32 is actively suctioned into the cylinder of the canister 41. Accordingly, even when the amount of the fuel in the fuel tank 31 becomes small, the canister 41 can be heated from the inner side of the cylinder.

### Fifth Embodiment

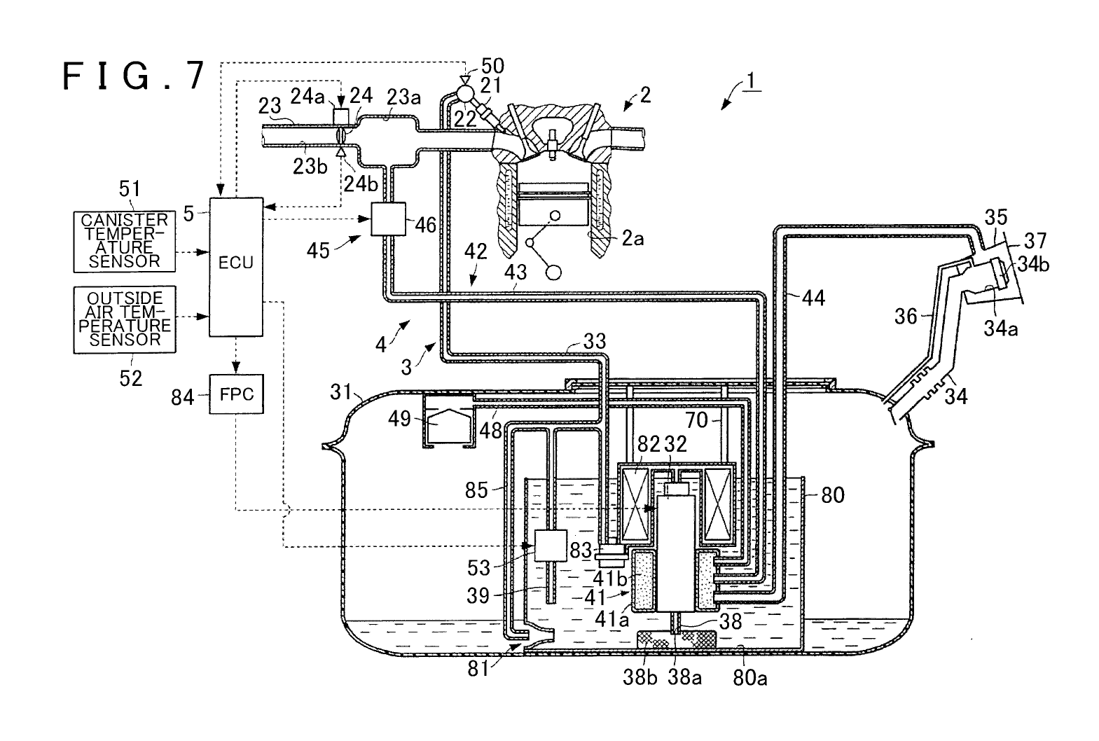

FIG. 7 shows a configuration of a main section of a vehicle in which an evaporated fuel processing device according to a fifth embodiment of the present invention is mounted, that is, mechanisms of an internal combustion engine for traveling and driving and a fuel system that supplies fuel and performs fuel purge.

In this embodiment, although the configurations of the canister and the vicinity thereof differ from those in the first embodiment, the configurations of the other main components are the same as those of the first embodiment. Thus, the same components as those in the first embodiment are denoted by the same reference numerals, and the following description will be made on differences from the first embodiment.

In this embodiment, the end side of the recirculation piping 39 that is in the vicinity of the discharge side of the fuel pump 32 is branched from the fuel supply pipe 33, and the other side thereof is opened downward near the inner bottom section of the fuel tank 31.

In addition, the canister 41 is in contact with the fuel pump 32. More specifically, the canister 41 is configured to surround the fuel pump 32. For example, the canister 41 is configured to have a cylindrical shape, so as to surround the fuel pump 32. In this way, the large contact area between the fuel pump 32 and the canister 41 can be obtained, and the large heat transfer amount can thereby be obtained.

As for the canister temperature increasing operation by the ECU 5 in this embodiment, it is the same as the canister temperature increasing operation by the ECU 5 in the first embodiment of the present invention. Thus, the description thereof will not be repeated.

As it has been described so far, the same effects as those obtained by the first embodiment of the present invention can be obtained by this embodiment. Particularly, in this embodiment, since the canister 41 is in contact with the fuel pump 32, the heat is transferred from the fuel pump 32 that is heated by being driven at the high driving voltage to the canister 41. Accordingly, the canister 41 can be heated.

Noted that, in this embodiment, the description has been made on an example in which the canister 41 is configured to be in contact with the fuel pump 32. However, there may be a slight space between the canister 41 and the fuel pump 32. In addition, the canister 41 and the fuel pump 32 may be in contact with each other via a metallic material having the high thermal conductivity or the like.

In addition, also in each of the first to fourth embodiments of the present invention, the canister 41 may be in contact with the fuel pump 32 as in this embodiment. With such a configuration, the canister 41 can further be heated.

As it has been described so far, the evaporated fuel processing device according to the present invention produces such an effect that the desorbing performance of the absorber can sufficiently be exerted in comparison with the conventional evaporated fuel processing device. The present invention is particularly useful for the evaporated fuel processing device in which the absorber is provided in the fuel tank.

### DESCRIPTION OF THE REFERENCE NUMERALS AND SYMBOLS

1/ VEHICLE
2/ ENGINE (INTERNAL COMBUSTION ENGINE)
3/ FUEL SUPPLY MECHANISM
4/ FUEL PURGE SYSTEM
5/ ECU (TRANSFERRED HEAT AMOUNT CONTROL SECTION, TEMPERATURE INCREASE REQUEST SECTION, FUEL PUMP CONTROL SECTION)
21/ INJECTOR
22/ DELIVERY PIPE
23/ INTAKE PIPE
23b/ INTAKE PASSAGE
24/ THROTTLE VALVE
31/ FUEL TANK
32/ FUEL PUMP
33/ FUEL SUPPLY PIPE
38/ INTAKE PIPING
38a/ INTAKE PASSAGE
38b/ SUCTION FILTER
39/ RECIRCULATION PIPING
41/ CANISTER (ABSORBER)
41b/ ABSORBENT
41c/ HEAT TRANSFER SURFACE
42/ PURGE MECHANISM
43/ PURGE PIPING
44/ ATMOSPHERE PIPING
45/ PURGE CONTROL MECHANISM
46/ PURGE VSV
51/ CANISTER TEMPERATURE SENSOR
53/ ON-OFF VALVE (RECIRCULATION FUEL ADJUSTMENT MECHANISM)
80/ INTERNAL TANK
81/ JET PUMP
82/ FUEL FILTER
84/ FPC (TRANSFERRED HEAT AMOUNT CONTROL SECTION, FUEL PUMP CONTROL SECTION)
85/ PILOT PIPING

1. An evaporated fuel processing device that includes:
a fuel tank that stores fuel for an internal combustion engine;
a fuel pump that pumps up the fuel that is supplied from the fuel tank to the internal combustion engine;
an absorber that is mounted in the fuel tank and absorbs evaporated fuel generated in the fuel tank;
a purge mechanism in which the evaporated fuel is introduced from the absorber into an intake pipe of the internal combustion engine,
the evaporated fuel processing device comprising:
a temperature increase request section that requests an increase of a temperature of the absorber; and
a transferred heat amount control section that increases an amount of heat transferred from the fuel pump to the absorber by changing a driving state of the fuel pump under a condition that the increase of the temperature of the absorber is requested by the temperature increase request section.

2. The evaporated fuel processing device according to claim 1, wherein the transferred heat amount control section increases the amount of heat that is transferred from the fuel pump to the absorber via the fuel.

3. The evaporated fuel processing device according to claim 2, wherein the transferred heat amount control section increases the amount of heat that is transferred from the fuel pump to the absorber via fuel that is discharged from the fuel pump.

4. The evaporated fuel processing device according to claim 3, wherein recirculation piping is provided that recirculates some of the fuel discharged from the fuel pump to an upstream side of the fuel pump.

5. The evaporated fuel processing device according to claim 4, wherein a portion of an intake passage that suctions fuel into the fuel pump is formed in the absorber, and the recirculation piping recirculates some of the fuel that is discharged from the fuel pump to the intake passage on an upstream side of the absorber.

6. The evaporated fuel processing device according to claim 4, wherein it is configured that a portion of the recirculation piping runs through the absorber.

7. The evaporated fuel processing device according to claim 4, wherein
the recirculation piping is provided with a recirculation fuel adjustment mechanism that can adjust a flow rate of fuel recirculated by the recirculation piping, and
the transferred heat amount control section controls the recirculation fuel adjustment mechanism so as to increase the flow rate of the fuel that is recirculated by the recirculation piping under a condition that the increase of the temperature of the absorber is requested by the temperature increase request section.

8. The evaporated fuel processing device according to claim 3, wherein a portion of a fuel supply passage that supplies the fuel from the fuel pump to the internal combustion engine is formed in the absorber.

9. The evaporated fuel processing device according to claim 1, wherein the absorber is in contact with the fuel pump.

10. The evaporated fuel processing device according to claim 1, wherein the transferred heat amount control section increases a driving force of the fuel pump and thereby increases the amount of heat that is transferred from the fuel pump to the absorber.

11. The evaporated fuel processing device according to claim 1, wherein
an internal tank is provided in the fuel tank, and
the internal tank houses the fuel pump and the absorber.

12. The evaporated fuel processing device according to claim 1, wherein the temperature increase request section requests the increase of the temperature of the absorber either when the purge mechanism executes the purge operation or when the purge mechanism has executed the purge operation.

13. The evaporated fuel processing device according to claim 1, wherein the temperature increase request section requests the increase of the temperature of the absorber under a condition that a load of the internal combustion engine becomes lower than a predetermined amount.

14. The evaporated fuel processing device according to claim 1, wherein the temperature increase request section requests the increase of the temperature of the absorber under a condition that an outside air temperature becomes lower than a predetermined temperature.

15. The evaporated fuel processing device according to claim 3, wherein
a fuel pump control section is provided that controls a driving voltage of the fuel pump so as to vary a discharging capacity in accordance with a load of the internal combustion engine, and
the temperature increase request section does not request the increase of the temperature of the absorber when the fuel pump is driven at a high driving voltage by the fuel pump control section.

16. The evaporated fuel processing device according to claim 3, wherein
the transferred heat amount control section increases the amount of heat that is transferred from the fuel pump to the absorber by increasing the driving voltage of the fuel pump in two stages.

17. The evaporated fuel processing device according to claim 16, wherein
recirculation piping is provided that recirculates some of the fuel discharged from the fuel pump to an upstream side of the fuel pump,
the recirculation piping is provided with a recirculation fuel adjustment mechanism that can adjust a flow rate of the fuel recirculated by the recirculation piping, and
the transferred heat amount control section controls the recirculation fuel adjustment mechanism to increase the flow rate of the fuel that is recirculated by the recirculation piping under conditions that the increase of the temperature of the absorber is requested by the temperature increase request section and that the driving voltage of the fuel pump is increased by the one stage.

18. The evaporated fuel processing device according to claim 17, wherein a fuel pressure in a delivery pipe that is provided in the internal combustion engine becomes lower after the recirculation fuel adjustment mechanism controls to increase the flow rate of the fuel that is recirculated by the recirculation piping than before the recirculation fuel adjustment mechanism controls to increase the flow rate of the fuel that is recirculated by the recirculation piping.

19. The evaporated fuel processing device according to claim 17, wherein the fuel pressure in the delivery pipe that is provided in the internal combustion engine becomes higher after the recirculation fuel adjustment mechanism controls to increase the flow rate of the fuel that is recirculated by the recirculation piping and then the transferred heat amount control section controls to increase the driving voltage of the fuel pump by the two stages than before the recirculation fuel adjustment mechanism controls to increase the flow rate of the fuel that is recirculated by the recirculation piping.

20. The evaporated fuel processing device according to claim 17, wherein
a current that flows through the fuel pump becomes lower after the recirculation fuel adjustment mechanism controls to increase the flow rate of the fuel that is recirculated by the recirculation piping than before the recirculation fuel adjustment mechanism controls to increase the flow rate of the fuel that is recirculated by the recirculation piping.

21. The evaporated fuel processing device according to claim 17, wherein
the current that flows through the fuel pump becomes higher after the recirculation fuel adjustment mechanism controls to increase the flow rate of the fuel that is recirculated by the recirculation piping and then the transferred heat amount control section controls to increase the driving voltage of the fuel pump by the two stages than before the recirculation fuel adjustment mechanism controls to increase the flow rate of the fuel that is recirculated by the recirculation piping.
